(19) United States
(12) Patent Application Publication
(10) Pub. No.: US 2026/0005902 A1
(43) Pub. Date: Jan. 1, 2026

(54) TRANSMITTER AND TRANSMISSION METHOD

(71) Applicant: Panasonic Holdings Corporation, Osaka (JP)

(72) Inventors: SHOTARO MAKI, Tokyo (JP); YASUAKI YUDA, Kanagawa (JP); AKIHIKO NISHIO, Osaka (JP)

(21) Appl. No.: 19/226,211

(22) Filed: Jun. 3, 2025

(30) Foreign Application Priority Data
Jun. 26, 2024 (JP) 2024-103036

(51) Int. Cl. H04L 27/20; H04W 72/0453

(52) U.S. Cl. CPC H04L 27/2082; H04W 72/0453

(57) ABSTRACT

A transmitter includes: processing circuitry which, in operation, performs correction processing on a first signal of a pair of transmission signals mapped to frequency resources symmetric with respect to a center frequency by using a second signal of the pair of transmission signals; and a quadrature modulator which, in operation, performs quadrature modulation on the pair of transmission signals after the correction processing.

### BACKGROUND

### 1. Technical Field

The present disclosure relates to a transmitter and a transmission method.

### 2. Description of the Related Art

Cellular wireless communication such as 5G New Radio access technology (NR) is performed.

### SUMMARY

However, there is room for study on a method for improving performance of wireless communication.

One non-limiting and exemplary embodiment facilitates providing a transmitter and a transmission method capable of improving performance of wireless communication.

A transmitter according to an exemplary embodiment of the present disclosure includes: processing circuitry which, in operation, performs correction processing on a first signal of a pair of transmission signals by using a second signal of the pair of transmission signals mapped to frequency resources symmetric with respect to a center frequency; and a quadrature modulator which, in operation, performs quadrature modulation on the pair of transmission signals after the correction processing.

It should be noted that general or specific embodiments may be implemented as a system, a method, an integrated circuit, a computer program, a storage medium, or any selective combination thereof.

According to an exemplary embodiment of the present disclosure, the performance of the wireless communication can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating a configuration example of a transmitter;

FIG. 2 is a diagram illustrating a configuration example of a transmitter;

FIG. 3 is a diagram illustrating a configuration example of a transmitter;

FIG. 4 is a diagram illustrating a configuration example of a part of a transmitter;

FIG. 5 is a diagram illustrating a configuration example of a transmitter;

FIG. 6 is a diagram illustrating a configuration example of a correction circuit;

FIG. 7 is a diagram illustrating a configuration example of a correction circuit;

FIG. 8 is a diagram illustrating a configuration example of a correction circuit;

FIG. 9 is a diagram illustrating a configuration example of a transmitter;

FIG. 10 is a diagram illustrating a configuration example of a transmitter; and

FIG. 11 is a diagram illustrating a configuration example of a transmitter.

### DETAILED DESCRIPTIONS

Hereinafter, exemplary embodiments of the present disclosure will be described in detail with reference to the drawings.

In cellular wireless communication including 5G NR, radio waves in a microwave band and a millimeter wave band are utilized. In a 6G system (sixth generation mobile communication system), utilization of radio waves in a terahertz band (alternatively, sub-terahertz band) of 100 GHz or more is further studied. For example, in Kosuke Yamazaki et al., “PROPOSAL FOR A USER-CENTRIC RAN ARCHITECTURE TOWARDS BEYOND 5G”, IEICE Technical Report, vol. 121, no. 189, SAT2021-43, pp. 4-10, October 2021, a system using a terahertz wave for communication near a terminal is proposed.

In the terahertz band, it is assumed that a wireless device transmits and receives a wireless signal using a wide radio frequency (RF) frequency bandwidth.

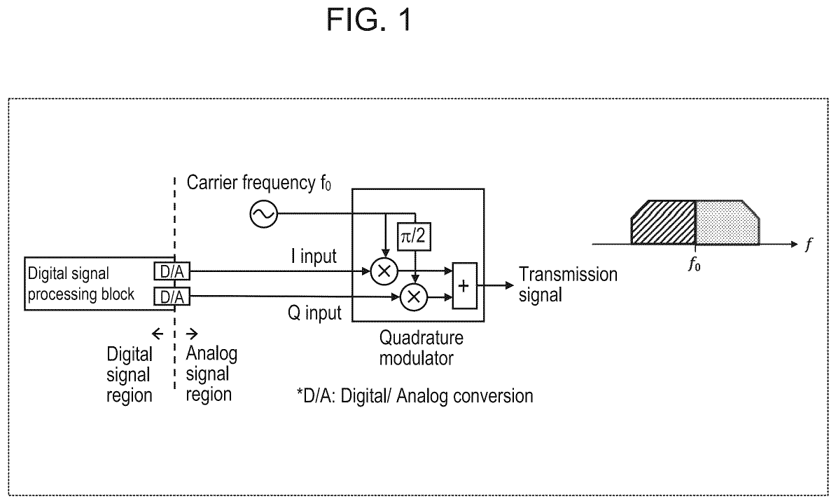

In a transmitter of a wireless device, a quadrature modulator may be used. FIG. 1 illustrates an example of a circuit configuration of a transmitter. In the example of FIG. 1, the transmission data is processed in a digital signal processing unit (also referred to as a digital signal processing block), undergoes digital-to-analog conversion (DA conversion), and is output as analog signals of an in-phase component (also referred to as In-Phase, I, I signal, or I component) and a quadrature-phase component (also referred to as Quadrature Phase, Q, Q signal, or Q component). The quadrature modulator modulates the analog signals of I and Q using the carrier signal (for example, the carrier frequency f₀) input from the local oscillator to output an RF transmission signal having the carrier frequency f₀ as the center frequency.

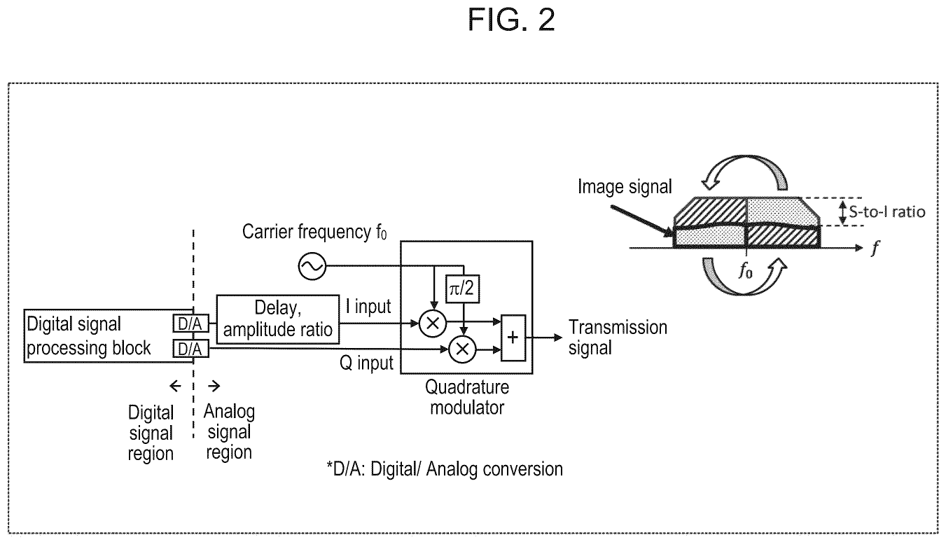

As described above, the inputs of I and Q to the quadrature modulator are analog signals. In the analog signal region, for example, as illustrated in FIG. 2, an amplitude offset or a timing offset (delay difference) may occur between the I signal and the Q signal due to a gain difference or a wiring length difference of the amplifier. Hereinafter, these are referred to as “I/Q offsets”.

When there is the I/Q offset, as illustrated in FIG. 2, an image signal appears in the output signal of the quadrature modulator at a frequency component symmetrical about the carrier frequency f₀ as viewed from the desired signal. Since the image signal acts as an interference component, quality (for example, SINR: Signal to Interference and Noise Ratio) of the transmission signal is deteriorated. For example, in broadband transmission, an image signal may also have a frequency characteristic because an I/Q offset may have a frequency characteristic.

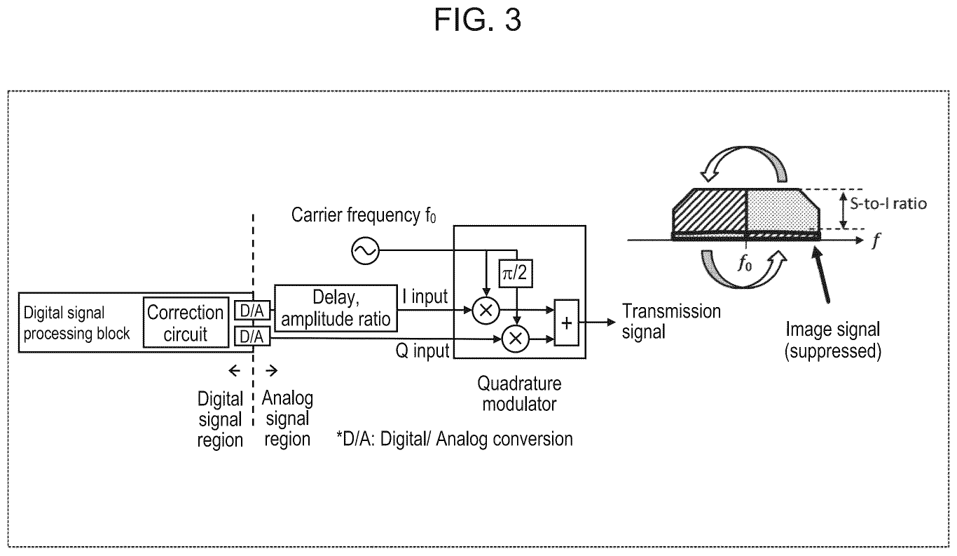

In a non-limiting and exemplary embodiment of the present disclosure, for example, a method of suppressing an image signal due to an I/Q offset in a quadrature modulator of a transmitter performing broadband transmission will be described. For example, as illustrated in FIG. 3, the transmitter suppresses the image signal by correcting the transmission signal in advance in the digital signal processing unit. For example, the transmitter corrects a transmission signal of each frequency by using a signal mapped to a frequency resource (for example, a subcarrier) that is symmetric with respect to a center frequency (for example, the carrier frequency f₀) as a pair. This suppresses the image signal and improves the signal quality (for example, SINR).

### [Overview of Communication System]

The communication system according to an exemplary embodiment of the present disclosure may include a plurality of wireless devices (for example, a communication device). The wireless device may include, for example, at least one of transmitter 100 that transmits a signal and a receiver that receives a signal. The wireless device may be, for example, either a base station (or a gNB, an access point,) or a terminal (or a mobile station, a user terminal, user equipment (UE), or a station (STA)). For example, the wireless device (for example, transmitter 100) may perform data transmission in the downlink, may perform data transmission in the uplink, or may perform data transmission between terminals (for example, side link data transmission).

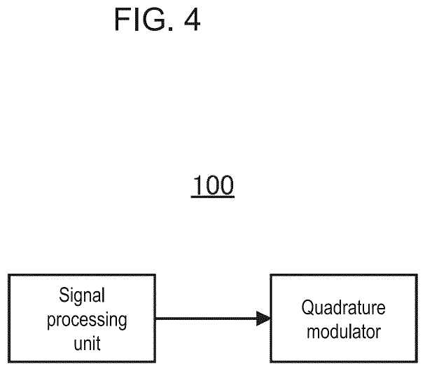

FIG. 4 is a block diagram illustrating a configuration example of a part of transmitter 100. In transmitter 100 illustrated in FIG. 4, the signal processing unit (for example, corresponding to processing circuit) uses one signal of the pair of transmission signals mapped to the frequency resources symmetric with respect to the center frequency to perform correction processing on the other signal of the pair of signals mapped to the symmetric frequency resource. The quadrature modulator performs quadrature modulation on the corrected transmission signal pair.

### [Configuration Example of Transmitter]

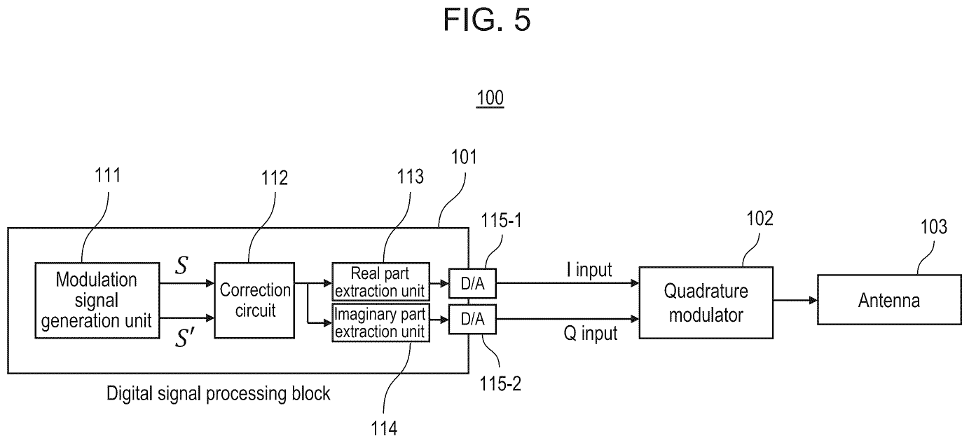

FIG. 5 is a block diagram illustrating a configuration example of transmitter 100 in the wireless device according to the present exemplary embodiment.

Transmitter 100 illustrated in FIG. 5 may include digital signal processing unit 101, quadrature modulator 102, and antenna 103 (for example, a transmission antenna).

Digital signal processing unit 101 performs digital signal processing on the transmission data. For example, digital signal processing unit 101 may perform inverse fast Fourier transform (IFFT) processing on a signal mapped to a frequency resource (for example, a subcarrier) (not illustrated).

Digital signal processing unit 101 may include, for example, modulation signal generation unit 111, correction circuit 112, real part extraction unit 113, imaginary part extraction unit 114, and digital-to-analog converter (D/A converter) 115.

Modulation signal generation unit 111 performs signal processing on the input data, and generates, for example, a modulation signal (hereinafter, represented by “s”) mapped to a subcarrier of frequency (+ω) and a modulation signal (hereinafter, represented by “s”) mapped to a subcarrier of frequency (−ω). Modulation signal generation unit 111 outputs the generated signals to correction circuit 112. Here, frequency +ω and frequency −ω are, for example, frequencies symmetric with respect to center frequency f₀ (for example, a pair of frequency resources).

Correction circuit 112 performs correction processing on modulation signals s and s′ input from modulation signal generation unit 111. For example, correction circuit 112 corrects modulation signals s and s′ so as to suppress the image signal. Correction circuit 112 outputs the corrected signals to real part extraction unit 113 and imaginary part extraction unit 114. Note that an example of correction processing in correction circuit 112 will be described later.

Real part extraction unit 113 extracts a real part (for example, the I component) of the signal input from correction circuit 112, and outputs the real part to D/A converter 115-1 on the I side. Imaginary part extraction unit 114 extracts an imaginary part (for example, the Q component) of the signal input from correction circuit 112, and outputs the imaginary part to D/A converter 115-2 on the Q side.

I side and Q side D/A converters 115 convert a signal (digital signal) input from real part extraction unit 113 or imaginary part extraction unit 114 into an analog signal, and output the analog signal to analog signal regions corresponding to the I side and the Q side of quadrature modulator 102.

Digital signal processing unit 101 has been described above.

Quadrature modulator 102 performs quadrature modulation on the signals input to the I side and the Q side, generates a transmission signal, and outputs the transmission signal to antenna 103.

Antenna 103 radiates a transmission signal input from quadrature modulator 102 toward other wireless devices (for example, the receiver).

### [Operation Example of Transmitter 100]

Next, an operation example of above-described transmitter 100 (for example, correction circuit 112) will be described. Correction circuit 112 performs correction processing on the basis of, for example, an I/Q offset (for example, an amplitude offset or a timing offset) between an I component and a Q component of the transmission signal.

### Operation Example 1

In operation example 1, correction circuit 112 suppresses the image signal by generating a component that cancels the I/Q offset using the modulation signals mapped to the frequency resources (a pair of frequency resources, for example, subcarriers) of the frequencies +ω and −ω.

For example, correction circuit 112 may correct the IFFT input signals corresponding to the subcarriers of the frequencies +ω and −ω using the modulation signal s corresponding to the subcarrier of the frequency +ω and the modulation signal s′ corresponding to the subcarrier of the frequency −ω input from modulation signal generation unit 111. For example, correction circuit 112 may generate the IFFT input signals as in following Expressions (1) and (2), respectively.

$$\begin{matrix}[ Math . 1 ] & \\ IFFT input signal corresponding to subcarrier of frequency + ω : \\ s \frac{\frac{1}{{V}_{R}} {e}^{+ j ω τ} + 1}{2} + {s}^{′ *} \frac{\frac{1}{{V}_{R}} {e}^{+ j ω τ} - 1}{2} & ( 1 )\end{matrix}$$

$$\begin{matrix}[ Math . 2 ] & \\ IFFT input signal corresponding to subcarrier of frequency - ω : \\ {s}^{*} \frac{\frac{1}{{V}_{R}} {e}^{- j ω τ} - 1}{2} + {s}^{′} \frac{\frac{1}{{V}_{R}} {e}^{- j ω τ} + 1}{2} & ( 2 )\end{matrix}$$

Here, V_{R} represents a correction value for an amplitude offset (a value obtained by dividing the amplitude of the I signal by the amplitude of the Q signal, an amplitude ratio) of the I signal and the Q signal in the analog section (analog signal region), and τ represents a correction value for a timing offset (delay amount of the I signal with respect to the Q signal) of the I signal and the Q signal in the analog section.

The IFFT output signal is output from correction circuit 112. The IFFT output signal (corrected transmission signal) includes a component for canceling the I/Q offset.

With the above correction, the I/Q offsets generated in the subcarriers of the frequencies +ω and −ω in the analog section are canceled, so that the image signal can be suppressed.

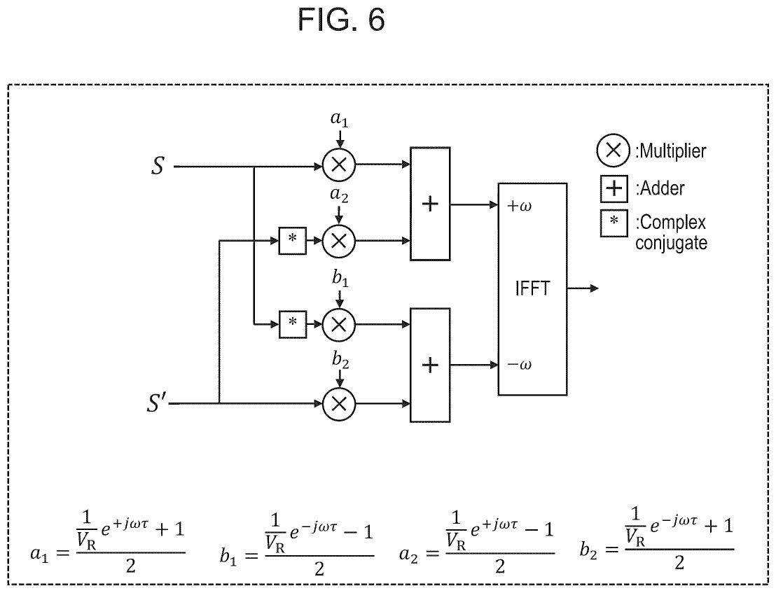

FIG. 6 illustrates an example of a circuit configuration of correction circuit 112 in operation example 1. In FIG. 6, s represents a modulation signal mapped to a subcarrier of frequency +ω, and s′ represents a modulation signal mapped to a subcarrier of frequency −ω.

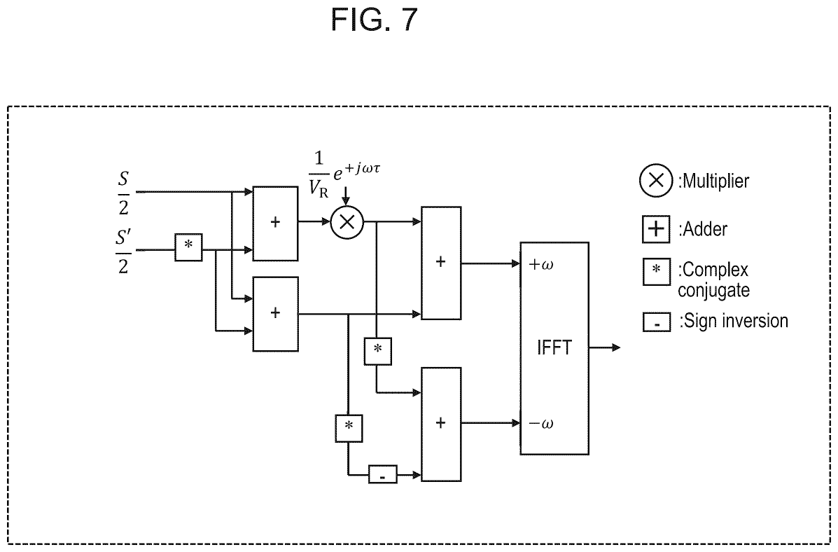

FIG. 7 illustrates another example of the circuit configuration of correction circuit 112 in operation example 1. In the configuration example illustrated in FIG. 7, the number of multipliers having a high calculation load is reduced as compared with FIG. 6 (for example, it is minimized). Furthermore, for example, in a case where correction value V_{R} is 1 in FIG. 7, a phase rotator that performs phase rotation of e^{+jωτ} can be used instead of the multiplier, so that the calculation load can be further reduced.

Correction circuit 112 illustrated in FIG. 6 or 7 obtains the IFFT input signals illustrated in Expressions (1) and (2).

Hereinafter, as an example, a procedure for deriving the above-described IFFT input value will be described.

In quadrature modulator 102, when the subcarrier of frequency +ω is modulated by modulation vector a, the modulation signal is represented by x(t)=ae^{+jωτ}. Real part Re[x(t)] and imaginary part Im[x(t)] of modulation signal x(t) are expressed by following Expression (3).

$$\begin{matrix}[ Math . 3 ] & \\ x ( t ) = ℛ e [ x ( t ) ] + j 𝒥𝓂 [ x ( t ) ] \\ ℛ e [ x ( t ) ] = \frac{x ( t ) + {x}^{*} ( t )}{2} = \frac{a {e}^{+ j ω t} + {a}^{*} {e}^{- j ω t}}{2} \\ 𝒥𝓂 [ x ( t ) ] = \frac{x ( t ) - {x}^{*} ( t )}{2 j} = \frac{a {e}^{+ j ω t} - {a}^{*} {e}^{- j ω t}}{2 j} & ( 3 )\end{matrix}$$

Here, assuming that time delay τ of real part Re[x(t)] and the amplitude ratio between the real part and the imaginary part are V_{R} as the I/Q offset, the real part of modulation signal x(t) is expressed as:

$$\begin{matrix}[ Math . 4 ] & \\ {V}_{R} ℛ e [ x ( t - τ ) ] = {V}_{R} \frac{{ae}^{+ j ω ( t - τ )} + {a}^{*} {e}^{- j ω ( t - τ )}}{2} = {V}_{R} \frac{{ae}^{- j ω τ} {e}^{+ j ω t} + {a}^{*} {e}^{+ j ω τ} {e}^{- j ω t}}{2} & \end{matrix}$$

Modulation signal x\hat{ }(t) output from quadrature modulator 102 is expressed by following Expression (4).

$$\begin{matrix}[ Math . 5 ] & \\ \hat{x} ( t ) = {V}_{R} ℛ e [ x ( t - τ ) ] + j 𝒥𝓂 [ x ( t ) ] = a \frac{{V}_{R} {e}^{- j ω τ} + 1}{2} {e}^{+ j ω t} + {a}^{*} \frac{{V}_{R} {e}^{+ j ω τ} - 1}{2} {e}^{- j ω t} & ( 4 )\end{matrix}$$

Similarly, in quadrature modulator 102, when the subcarrier of frequency −ω is modulated by modulation vector b, the modulation signal is represented by y(t)=be^{-jωτ}. Assuming that time delay τ of real part Re[y(t)] of modulation signal y(t) and the amplitude ratio between the real part and the imaginary part are V_{R} as the I/Q offset, modulation signal y\hat{ }(t) output from quadrature modulator 102 is expressed by following Expression (5).

$$\begin{matrix}[ Math . 6 ] & \\ \hat{y} ( t ) = b \frac{{V}_{R} {e}^{+ j ω τ} + 1}{2} {e}^{- j ω t} + {b}^{*} \frac{{V}_{R} {e}^{- j ω τ} - 1}{2} {e}^{+ j ω t} & ( 5 )\end{matrix}$$

Therefore, the transmission signal output from quadrature modulator 102 obtained by modulating the subcarriers of frequencies +ω and −ω with modulation vector a and modulation vector b, respectively, is expressed by following Expression (6).

$$\begin{matrix}[ Math . 7 ] & \\ \hat{x} ( t ) + \hat{y} ( t ) = a \frac{{y}_{R} {e}^{- j ω τ} + 1}{2} {e}^{+ j ω t} + {a}^{*} \frac{{y}_{R} {e}^{+ j ω τ} - 1}{2} {e}^{- j ω t} + b \frac{{y}_{R} {e}^{+ j ω τ} + 1}{2} {e}^{- j ω t} + {b}^{*} \frac{{y}_{R} {e}^{- j ω τ} - 1}{2} {e}^{+ j ω t} = ( a \frac{{y}_{R} {e}^{- j ω τ} + 1}{2} + {b}^{*} \frac{{y}_{R} {e}^{- j ω τ} - 1}{2} ) {e}^{+ j ω t} + ( {a}^{*} \frac{{y}_{R} {e}^{+ j ω τ} - 1}{2} + b \frac{{y}_{R} {e}^{+ j ω τ} + 1}{2} ) {e}^{- j ω t} & ( 6 )\end{matrix}$$

On the other hand, in the subcarrier of the frequency +ω to which the modulation signal s is mapped, the image signal and the transmission signal without the I/Q offset are expressed by following Expression (7).

$$\begin{matrix}[ Math . 8 ] & \\ \hat{x} ( t ) + \hat{y} ( t ) = s {e}^{+ j ω t} & ( 7 )\end{matrix}$$

Therefore, coefficient a of the IFFT input signal corresponding to the subcarrier of frequency +ω and coefficient b of the IFFT input signal corresponding to the subcarrier of frequency −ω for removing the image signal from the subcarrier of frequency +ω are obtained by solving simultaneous equations expressed by following Expression (8) from Expressions (6) and (7).

$$\begin{matrix}[ Math . 9 ] & \\ \{ \begin{matrix}a \frac{{V}_{R} {e}^{- j ω τ} + 1}{2} + {b}^{*} \frac{{V}_{R} {e}^{- j ω τ} - 1}{2} = s & ( 8 - 1 ) \\ {a}^{*} \frac{{V}_{R} {e}^{+ j ω τ} - 1}{2} + b \frac{{V}_{R} {e}^{+ j ω τ} + 1}{2} = 0 & ( 8 - 2 )\end{matrix} & ( 8 )\end{matrix}$$

Following Expression (9) is obtained by taking the complex conjugate of Expression (8-2).

$$\begin{matrix}[ Math . 10 ] & \\ 0 = a \frac{{V}_{R} {e}^{- j ω τ} - 1}{2} + {b}^{*} \frac{{V}_{R} {e}^{- j ω τ} + 1}{2} ⇔ {b}^{*} = - a \frac{{V}_{R} {e}^{- j ω τ} - 1}{2} \frac{2}{{V}_{R} {e}^{- j ω τ} + 1} = - a \frac{{V}_{R} {e}^{- j ω τ} - 1}{{V}_{R} {e}^{- j ω τ} + 1} & ( 9 )\end{matrix}$$

Substituting b* shown in Expression (9) into Expression (8-1) gives following Expression (10).

$$\begin{matrix}[ Math . 11 ] & \\ s = a \frac{{V}_{R} {e}^{- j ω τ} + 1}{2} - a \frac{{V}_{R} {e}^{- j ω τ} - 1}{{V}_{R} {e}^{- j ω τ} + 1} \frac{{V}_{R} {e}^{- j ω τ} - 1}{2} = a \frac{{( {V}_{R} {e}^{- j ω τ} + 1 )}^{2} - {( {V}_{R} {e}^{- j ω τ} - 1 )}^{2}}{2 ( {V}_{R} {e}^{- j ω τ} + 1 )} = a \frac{4 {V}_{R} {e}^{- j ω τ}}{2 ( {V}_{R} {e}^{- j ω τ} + 1 )} ⇔ a = s \frac{{V}_{R} {e}^{- j ω τ} + 1}{2 {V}_{R} {e}^{- j ω τ}} = s \frac{\frac{1}{{V}_{R}} {e}^{+ j ω τ} + 1}{2} & ( 10 )\end{matrix}$$

Furthermore, substituting a shown in Expression (10) into the complex conjugate of Expression (8-1) gives following Expression (11).

$$\begin{matrix}[ Math . 12 ] & \\ {s}^{*} = {a}^{*} \frac{{V}_{R} {e}^{+ j ω τ} + 1}{2} + b \frac{{V}_{R} {e}^{+ j ω τ} - 1}{2} = {s}^{*} \frac{\frac{1}{{V}_{R}} {e}^{- j ω τ} + 1}{2} \frac{{V}_{R} {e}^{+ j ω τ} + 1}{2} + b \frac{{V}_{R} {e}^{+ j ω τ} - 1}{2} ⇔ {s}^{*} \frac{4 - ( 2 + \frac{1}{{V}_{R}} {e}^{- j ω τ} + {V}_{R} {e}^{+ j ω τ} )}{4} = \frac{2 b ( {V}_{R} {e}^{+ j ω τ} - 1 )}{4} ⇔ b = {s}^{*} \frac{2 - \frac{1}{{V}_{R}} {e}^{- j ω τ} - {V}_{R} {e}^{+ j ω τ}}{4} \frac{4}{2 ( {V}_{R} {e}^{+ j ω τ} - 1 )} = {s}^{*} \frac{( {V}_{R} {e}^{+ j ω τ} - 1 ) ( \frac{1}{{V}_{R}} {e}^{- j ω τ} - 1 )}{2 ( {V}_{R} {e}^{+ j ω τ} - 1 )} = {s}^{*} \frac{\frac{1}{{V}_{R}} {e}^{- j ω τ} - 1}{2} & ( 11 )\end{matrix}$$

From the above, coefficient a (for example, corresponding to ais illustrated in FIG. 6) of the IFFT input signal corresponding to the subcarrier of frequency +ω and coefficient b (for example, corresponding to b₁s* illustrated in FIG. 6) of the IFFT input signal corresponding to the subcarrier of frequency −ω for removing the image signal from the subcarrier of frequency +ω to which modulation signal s is mapped are obtained by following Expressions (12) and (13).

$$\begin{matrix}[ Math . 13 ] & \\ a = s \frac{\frac{1}{{V}_{R}} {e}^{+ j ω τ} + 1}{2} & ( 12 )\end{matrix}$$

$$\begin{matrix}[ Math . 14 ] & \\ b = {s}^{*} \frac{\frac{1}{{V}_{R}} {e}^{- j ω τ} - 1}{2} & ( 13 )\end{matrix}$$

Similarly, in the subcarrier of frequency −ω to which modulation signal s′ is mapped, the image signal and the transmission signal without the I/Q offset are expressed by following Expression (14).

$$\begin{matrix}[ Math . 15 ] & \\ \hat{x} ( t ) + \hat{y} ( t ) = {s}^{′} {e}^{- j ω t} & ( 14 )\end{matrix}$$

Therefore, by solving simultaneous equations of following Expression (15) from Expressions (6) and (14), coefficient a of the IFFT input signal corresponding to the subcarrier of frequency +ω and coefficient b of the IFFT input signal corresponding to the subcarrier of frequency −ω for removing the image signal from the subcarrier of frequency −ω are obtained.

$$\begin{matrix}[ Math . 16 ] & \\ \{ \begin{matrix}a \frac{{V}_{R} {e}^{- j ω τ} + 1}{2} + {b}^{*} \frac{{V}_{R} {e}^{- j ω τ} - 1}{2} = 0 & ( 15 - 1 ) \\ {a}^{*} \frac{{V}_{R} {e}^{+ j ω τ} + 1}{2} + b \frac{{V}_{R} {e}^{+ j ω τ} - 1}{2} = {s}^{′} & ( 15 - 2 )\end{matrix} & ( 15 )\end{matrix}$$

By solving Expression (15), coefficient a (for example, corresponding to a₂s′* illustrated in FIG. 6) of the IFFT input signal corresponding to the subcarrier of frequency +ω and coefficient b (for example, corresponding to b₂s′ illustrated in FIG. 6) of the IFFT input signal corresponding to the subcarrier of frequency −ω for removing the image signal from the subcarrier of frequency −ω to which the modulation signal s′ is mapped are obtained by following Expressions (16) and (17).

$$\begin{matrix}[ Math . 17 ] & \\ a = {s}^{′ *} \frac{\frac{1}{{V}_{R}} {e}^{+ j ω τ} - 1}{2} & ( 16 )\end{matrix}$$

$$\begin{matrix}[ Math . 18 ] & \\ b = {s}^{′} \frac{\frac{1}{{V}_{R}} {e}^{- j ω τ} + 1}{2} & ( 17 )\end{matrix}$$

Then, for example, the IFFT input signal (corrected modulation signal) corresponding to the subcarrier of frequency +ω is obtained by Expressions (12) and (16), and the IFFT input signal (corrected modulation signal) corresponding to the subcarrier of frequency −ω is obtained by Expressions (13) and (17).

When the above-described corrected modulation signal is subjected to quadrature modulation in quadrature modulator 102, transmitter 100 can extract a signal in which an image signal component by paired frequencies (−ω and +ω) is canceled out from subcarriers of frequencies +ω and −ω, for example, as shown in Expressions (7) and (14). Furthermore, for example, as shown in Expressions (7) and (14), in the extracted signal, distortion (for example, amplitude and timing offset components) in desired signals s and s′ of each frequency (+ω and −ω) can also be suppressed.

As described above, in operation example 1, the image signal and the transmission signal without the I/Q offset as illustrated in Expressions (7) and (14) can be obtained by performing the correction to suppress the image signal on modulation signals s and s′. Furthermore, in operation example 1, in addition to the image signal, distortion (for example, amplitude and timing offset components) in desired signals s and s′ can also be suppressed.

### Operation Example 2

In operation example 2, correction circuit 112 suppresses the image signal by subtracting an image signal component due to the I/Q offset from the modulation signals mapped to the frequency resources (a pair of frequency resources, for example, subcarriers) of the frequencies +ω and −ω.

For example, correction circuit 112 may correct the IFFT input signals corresponding to the subcarriers of the frequencies +ω and −ω using the modulation signal s corresponding to the subcarrier of the frequency +ω and the modulation signal s′ corresponding to the subcarrier of the frequency −ω input from modulation signal generation unit 111. For example, correction circuit 112 may generate the IFFT input signals as in following Expressions (18) and (19), respectively.

$$\begin{matrix}[ Math . 19 ] & \\ IFFT input signal corresponding to subcarrier of frequency + ω : & ( 18 )\end{matrix}$$

$$s - {s}^{′ *} \frac{{V}_{R} {e}^{- j ω τ} - 1}{{V}_{R} {e}^{- j ω τ} + 1}$$

$$\begin{matrix}[ Math . 20 ] & \\ IFFT input signal corresponding to subcarrier of frequency - ω : & ( 19 )\end{matrix}$$

$${s}^{′} - {s}^{*} \frac{{V}_{R} {e}^{+ j ω τ} - 1}{{V}_{R} {e}^{+ j ω τ} + 1}$$

Here, V_{R} represents a correction value for an amplitude offset (a value obtained by dividing the amplitude of the I signal by the amplitude of the Q signal, an amplitude ratio) of the I signal and the Q signal in the analog section (analog signal region), and τ represents a correction value for a timing offset (delay amount of the I signal with respect to the Q signal) of the I signal and the Q signal in the analog section.

The IFFT output signal is output from correction circuit 112. The IFFT output signal (corrected transmission signal) is a signal obtained by subtracting an image signal component that can occur in the analog section.

With the above correction, in the corrected modulation signal, an assumed image signal component is subtracted in advance in the digital signal processing, so that the image signal can be suppressed even when the image signal component is generated in the subcarriers of the frequencies +ω and −ω in the analog section.

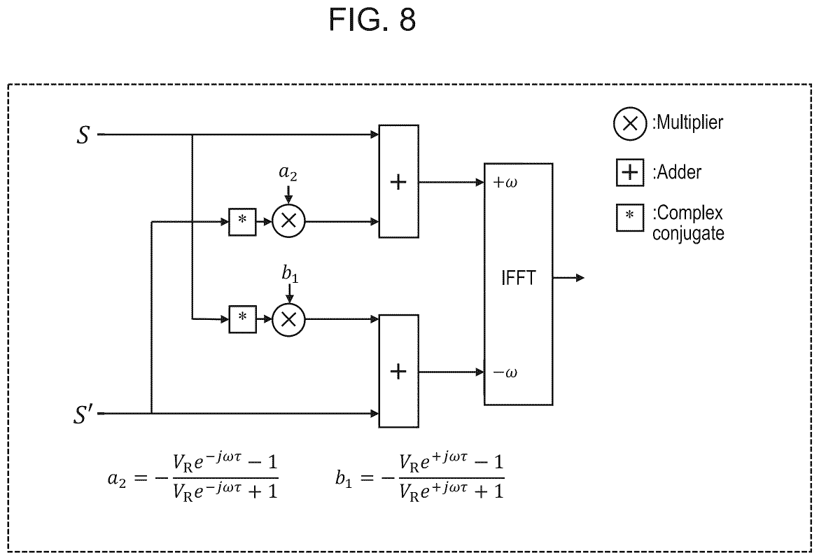

FIG. 8 illustrates an example of a circuit configuration of correction circuit 112 in operation example 2. In FIG. 8, s represents a modulation signal mapped to a subcarrier of frequency +ω, and s′ represents a modulation signal mapped to a subcarrier of frequency −ω.

Correction circuit 112 illustrated in FIG. 8 obtains the IFFT input signals illustrated in Expressions (18) and (19).

Hereinafter, as an example, a procedure for deriving the above-described IFFT input value will be described.

Similarly to operation example 1, when quadrature modulator 102 modulates subcarriers of frequencies +ω and −ω with modulation vector a and modulation vector b, respectively, a transmission signal output from quadrature modulator 102 is expressed by following Expression (20).

$$\begin{matrix}[ Math . 21 ] & \\ \hat{x} ( t ) + \hat{y} ( t ) = ( a \frac{{V}_{R} {e}^{- j ω τ} + 1}{2} + {b}^{*} \frac{{V}_{R} {e}^{- j ω τ} - 1}{2} ) {e}^{+ j ω t} + ( {a}^{*} \frac{{V}_{R} {e}^{+ j ω τ} - 1}{2} + b \frac{{V}_{R} {e}^{+ j ω τ} + 1}{2} ) {e}^{- j ω t} & ( 20 )\end{matrix}$$

Here, in order to remove the image signal from the subcarrier of frequency +ω to which modulation signal s is mapped, values of a and b may be given such that the term of e^{-jωτ} in above Expression (20) becomes 0. For example, when a=s is set, following Expression (21) is obtained.

$$\begin{matrix}[ Math . 22 ] & \\ {s}^{*} \frac{{V}_{R} {e}^{+ j ω τ} - 1}{2} + b \frac{{V}_{R} {e}^{+ j ω τ} + 1}{2} = 0 ⇔ b = - {s}^{*} \frac{{V}_{R} {e}^{+ j ω τ} - 1}{{V}_{R} {e}^{+ j ω τ} + 1} & ( 21 )\end{matrix}$$

From Expression (21), coefficient a of the IFFT input signal corresponding to the subcarrier of frequency +ω and coefficient b (for example, corresponding to b₁s* illustrated in FIG. 8) of the IFFT input signal corresponding to the subcarrier of frequency −ω for removing the image signal from the subcarrier of frequency +ω to which modulation signal s is mapped are obtained by following Expression (22).

$$\begin{matrix}[ Math . 23 ] & \\ a = s & ( 22 )\end{matrix}$$

$$b = - {s}^{*} \frac{{V}_{R} {e}^{+ j ω τ} - 1}{{V}_{R} {e}^{+ j ω τ} + 1}$$

Similarly, in order to remove the image signal from the subcarrier of frequency −ω to which modulated signal s′ is mapped, values of a and b may be given such that the term of e^{+jωτ} in above Expression (20) becomes 0. For example, when b=s′ is set, following Expression (23) is obtained.

$$\begin{matrix}[ Math . 24 ] & \\ a \frac{{V}_{R} {e}^{- j ω τ} + 1}{2} + {s}^{′ *} \frac{{V}_{R} {e}^{- j ω τ} - 1}{2} = 0 ⇔ a = - {s}^{′ *} \frac{{V}_{R} {e}^{- j ω τ} - 1}{{V}_{R} {e}^{- j ω τ} + 1} & ( 23 )\end{matrix}$$

From Expression (23), coefficient a (for example, corresponding to a₂s′* illustrated in FIG. 8) of the IFFT input signal corresponding to the subcarrier of frequency +ω and coefficient b of the IFFT input signal corresponding to the subcarrier of frequency −ω for removing the image signal from the subcarrier of frequency −ω to which modulation signal s′ is mapped are obtained by Expression (24).

$$\begin{matrix}[ Math . 25 ] & \\ a = - {s}^{′ *} \frac{{V}_{R} {e}^{- j ω τ} - 1}{{V}_{R} {e}^{- j ω τ} + 1} & ( 24 )\end{matrix}$$

$$b = {s}^{′}$$

When the above-described corrected modulation signal is subjected to quadrature modulation by quadrature modulator 102, transmitter 100 can extract, for example, a signal in which a component (image signal component) of a term of e^{-jωτ} is suppressed from the subcarrier of frequency +ω, and can extract a signal in which a component (image signal component) of a term of e^{+jωτ} is suppressed from the subcarrier of frequency −ω.

As described above, in operation example 2, the transmission signal in which the image signal is suppressed can be obtained by performing the correction to subtract the image signal component from modulation signals s and s′.

The operation example of transmitter 100 has been described above.

In the present exemplary embodiment, transmitter 100 uses one of the transmission signals mapped to the frequency resources (frequencies + and −ω) symmetric with respect to center frequency f₀ to perform correction processing on the other of the transmission signals mapped to the symmetric frequency resources, and orthogonally modulates the transmission signal after the correction processing. As described above, transmitter 100 can suppress the image signal (for example, an image signal appearing in a frequency component symmetrical about the center frequency f₀) generated in the analog section by correcting the transmission signal (modulation signal) in advance in digital signal processing unit 101 (digital signal region) so that the influence of the image signal caused by the I/Q offset that can be generated in the analog section (for example, an analog signal region) is reduced, and thus the signal quality (alternatively, the error rate characteristic) can be improved.

Therefore, according to the present exemplary embodiment, the performance of wireless communication can be improved.

### [Other Operation Examples]

### <Method for Determining I/Q Offset Correction Value>

In each of the above operation examples, I/Q amplitude offset V_{R} and the correction value of timing offset τ (correction value of the I/Q offset) used for the correction processing in correction circuit 112 may be determined, for example, by directly measuring hardware. For example, a time domain reflectometry (TDR) method or the like may be used for measuring timing offset t. Alternatively, the correction value of the I/Q offset may be estimated using information such as circuit design or board design.

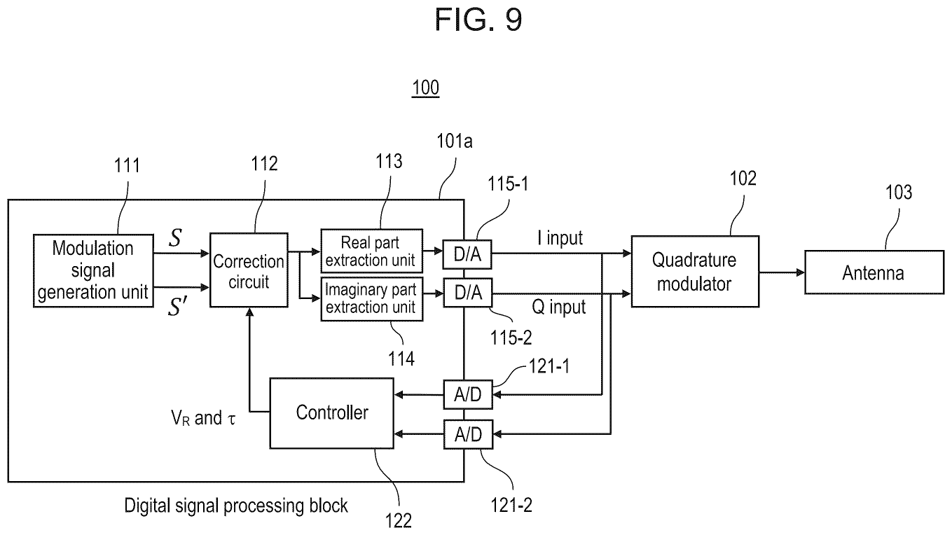

Alternatively, the correction value of the I/Q offset may be determined by a wireless device (for example, transmitter 100). FIG. 9 illustrates another configuration example of transmitter 100. In transmitter 100 illustrated in FIG. 9, digital signal processing unit 101a may include analog/digital converter (A/D converter) 121 and controller 122 in addition to the configuration of digital signal processing unit 101 illustrated in FIG. 5. In digital signal processing unit 101a, for example, an analog I/Q signal of an input portion of quadrature modulator 102 may be measured and input to controller 122 via A/D converter 121. Controller 122 may determine each correction value (for example, V_{R} and τ) of the I/Q offset on the basis of the input measurement value and output the correction value to correction circuit 112. At this time, the wiring length between A/D converter 121 and the input portion of quadrature modulator 102 may be laid out so as to be as short as possible. As a result, the influence of the amplitude and the timing offset due to the wiring between A/D converter 121 and the input portion of quadrature modulator 102 is reduced, and the I/Q offset in quadrature modulator 102 can be measured with high accuracy. Alternatively, the input of quadrature modulator 102 may be branched and input to a frequency converter or an envelope detector (not shown), down-converted to a low frequency (or direct current), and the down-converted signal may be input to A/D converter 121. As a result, it is possible to reduce the loss due to the wiring until being input to A/D converter 121, and it is possible to measure the I/Q offset in quadrature modulator 102 with high accuracy.

Alternatively, the correction value of the I/Q offset may be determined based on the measurement value of the image signal. For example, a measurement device (for example, it may or may not be included in the wireless device) may measure the image signal while changing correction values V_{R} and τ of the I/Q offset, and calibrate (calibrate) the correction value so that the power of the image signal is minimized.

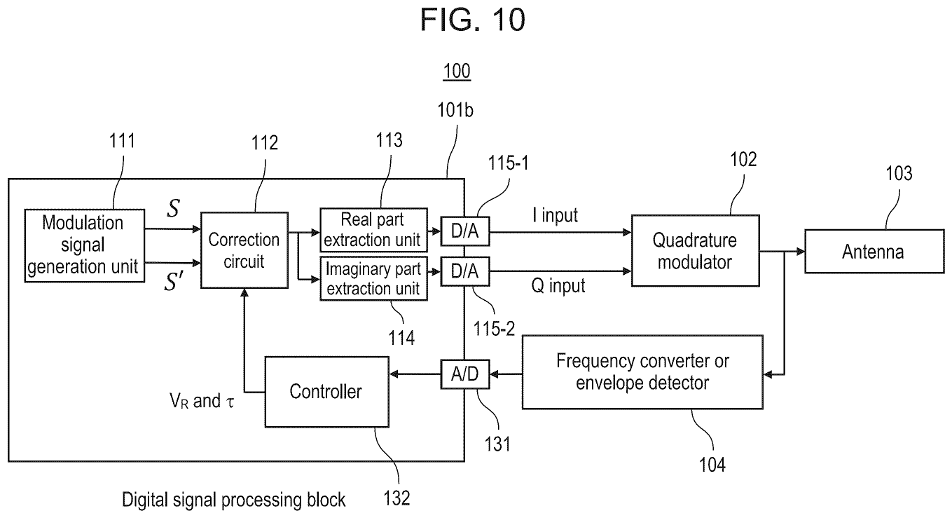

At this time, an image signal measurement function may be included in the wireless device. FIG. 10 illustrates another configuration example of transmitter 100. Transmitter 100 illustrated in FIG. 10 includes a frequency converter or envelope detector 104 in addition to the configuration illustrated in FIG. 5. Furthermore, digital signal processing unit 101b may include analog/digital converter (A/D converter) 131 and controller 132 in addition to the configuration of digital signal processing unit 101 illustrated in FIG. 5. The frequency converter or envelope detector 104 performs frequency conversion or envelope detection on the output of quadrature modulator 102 to down-convert the output into a baseband frequency band (or direct current), and outputs the down-converted output to digital signal processing unit 101b. The down-converted signal may be input to controller 132 via A/D converter 131. Controller 132 may determine each correction value (for example, V_{R} and τ) of the I/Q offset on the basis of the input measurement value and output the correction value to correction circuit 112.

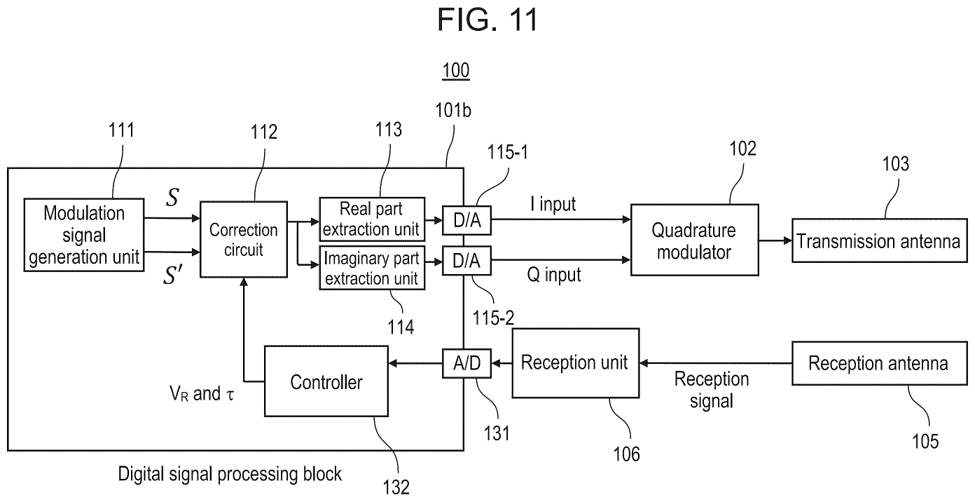

Alternatively, an image signal measurement device may be present outside the wireless device. From the measurement device of the image signal, feedback regarding the measurement value may be transmitted to a wireless device (for example, transmitter 100). FIG. 11 illustrates another configuration example of transmitter 100. Transmitter 100 illustrated in FIG. 11 includes reception antenna 105 and reception unit 106 in addition to the configuration illustrated in FIG. 5. Furthermore, digital signal processing unit 101b may include analog/digital converter (A/D converter) 131 and controller 132 in addition to the configuration of digital signal processing unit 101 illustrated in FIG. 5. Reception unit 106 receives feedback information regarding the measurement value of the image signal included in the signal received via reception antenna 105, and outputs the feedback information to digital signal processing unit 101b. The feedback information may be input to controller 132 via A/D converter 131. Controller 132 may determine each correction value (for example, V_{R} and τ) of the I/Q offset on the basis of the feedback information regarding the input measurement value and output the correction value to correction circuit 112.

The feedback information from the measurement device may be notified by a wireless signal. The method of the wireless signal may be a method conforming to 3GPP NR, and for example, a control signal (L1 control signal, medium access control (MAC), radio resource control (RRC)) in NR may be used.

In addition, at the time of measuring the image signal, a signal (test signal) of a subcarrier corresponding to a specific frequency +ω may be transmitted from the wireless device, and other signals may not be transmitted. At this time, the measurement device may determine the magnitude of the image signal by measuring subcarriers corresponding to frequency +ω and frequency −ω. Further, for example, the measurement device may instruct the wireless device in advance to transmit a test signal. Similarly to the feedback information, a wireless signal or a 3GPP NR-compliant signal may be used for this instruction.

Furthermore, for example, a signal obtained by modulating data may be transmitted from the wireless device. At this time, the measurement device may estimate or determine the magnitude of the image signal based on the quality (for example, indices such as SINR, a bit error rate (BER), a block error rate (BLER), and a packet error rate (PER)) of the received signal.

Note that the measurement and determination of the correction value of the I/Q offset and the measurement of the image signal may be performed once at the time of factory shipment or initial activation of the wireless device, may be performed every time the wireless device is activated, or may be periodically performed during operation. For example, by periodically changing the correction value, transmitter 100 can appropriately suppress the image signal even in a case where the I/Q offset temporally changes due to temperature characteristics, deterioration of components in the device, and the like.

In addition, regarding the correction using the determined correction value of the I/Q offset, transmitter 100 may adjust one of the amplitude and the timing first, and then adjust the other. Alternatively, transmitter 100 may adjust either the amplitude or the timing.

### <Compensation of I/Q Offset Having Frequency Characteristics>

A parameter such as a correction value (for example, V_{R} and τ) used to correct the I/Q offset described above may be set for each frequency (for example, a frequency resource). For example, each correction value may be a function having frequency ω such as V_{R}(ω) and τ(ω) as variables.

For example, in a case where the transmission frequency band is wide and the frequency characteristic of the actual I/Q offset is likely to greatly fluctuate, the image signal can be suppressed by setting the correction value according to the frequency characteristic of the I/Q offset.

Furthermore, transmitter 100 may determine the frequency granularity, which is a unit for performing the correction processing, according to the magnitude of change in the frequency direction of the I/Q offset (for example, the amount of change), for example. For example, the larger the change amount of the I/Q offset in the frequency direction, the smaller the frequency granularity at which the correction processing is performed may be set.

For example, when the change amount of the I/Q offset is large (for example, in a case where it is equal to or greater than the threshold value), the frequency granularity of the correction may be set to be small. For example, when the change amount of the I/Q offset is large, the frequency granularity of correction may be in units of subcarriers. As a result, the I/Q offset can be compensated with high accuracy.

On the other hand, for example, when the change amount of the I/Q offset is small (for example, in a case where the value is less than the threshold), the frequency granularity of correction may be set large. For example, when the change amount of the I/Q offset is small, the frequency granularity of correction may be in units of a plurality of subcarriers, in units of resource blocks (RBs), or in units of a plurality of RBs. As a result, the amount of calculation required for correction can be reduced.

In addition, the control signal used for the feedback may include, for example, information related to at least one of the magnitude of the image signal, the power ratio (for example, IMRR (Image Rejection Ratio)) between the desired signal and the image signal, the I/Q amplitude offset, the I/Q timing offset, and the quality (for example, an index such as SINR, BER, BLER, or PER) of the received signal, or other information related to the image signal. In addition, these pieces of information may be notified using different fields for each certain frequency unit. The frequency unit may be, for example, a subcarrier unit, a plurality of subcarrier units, an RB unit, or a plurality of RB units. Furthermore, the size of the frequency unit may be set according to the magnitude (change amount) of the change of the I/Q offset in the frequency direction. For example, when the change amount of the I/Q offset is large (for example, in a case where it is equal to or greater than the threshold), the size of the frequency unit may be set small. As a result, the information regarding the image signal can be fed back with high accuracy. On the other hand, for example, when the change amount of the I/Q offset is small (for example, in a case where the value is less than the threshold), the size of the frequency unit may be set large. As a result, the overhead of the control signal can be reduced.

In addition, the control signal used for the feedback may include, for example, information (for example, the index) related to at least one of features such as “the image signal is large”, “the IMRR is small”, “the I/Q offset is large”, or “the quality of the received signal is poor”, or a frequency resource (for example, an index of a subcarrier, a subcarrier group, an RB, or an RB group) that satisfies other features related to the image signal. Therefore, the wireless device can specify the frequency resource affected by the image signal, can properly correct the frequency resource, and can reduce the overhead of the control signal.

### <Others>

For the I/Q amplitude offset correction value, the value of V_{R} may be set to be larger than 1 or smaller than 1. For example, the amplitude offset may be corrected for both cases where the amplitude of the I signal is larger and smaller than the Q signal.

In addition, the value of V_{R} may be 1. That is, transmitter 100 may have a circuit configuration that corrects the I/Q timing offset and does not correct the I/Q amplitude offset.

For the I/Q timing offset correction value, the value of τ may be a positive value or a negative value. For example, the timing offset may be corrected for both a case where the I signal is delayed and a case where the I signal is advanced as compared with the Q signal.

The value of τ may be 0. That is, transmitter 100 may have a circuit configuration that corrects the I/Q amplitude offset and does not correct the I/Q timing offset.

The exemplary embodiment of the present disclosure has been described above.

Although the microwave band, the millimeter wave band, and the terahertz band (alternatively, the sub-terahertz band) have been described as examples of the wireless frequency band, the present invention is not limited thereto, and the frequency band used for transmission or reception may be another frequency band or a combination of these frequency bands.

In addition, in the above exemplary embodiment, the notation “ . . . unit” may be replaced with another notation such as “ . . . circuit (circuitry)”, “ . . . device”, “ . . . unit” or “ . . . module”.

### (Control Signal)

In the above exemplary embodiment, the control signal may be a PDCCH that transmits DCI of a physical layer, or may be an upper layer signal (for example, MAC or RRC). In addition, the data signal may include an upper layer signal.

### (Base Station)

In the present exemplary embodiment, the base station may be a transmission reception point (TRP), a cluster head, an access point, a remote radio head (RRH), an eNodeB (eNB), a gNodeB (gNB), a base station (BS), a base transceiver station (BTS), a master unit, a gateway, or the like. In the sidelink communication, a terminal may perform the sidelink communication instead of the base station.

### (Uplink and Downlink)

In the above exemplary embodiment, although the downlink has been described as an example, the present disclosure can also be applied to the PUSCH in the uplink. For example, the PDCCH in the operation example may be a PUCCH.

### (Data Channel and Control Channel)

In the above exemplary embodiment, the resource of the PDSCH or the PUSCH may be allocated by the PDCCH, or may be a resource configured by an upper layer signal.

### (Reference Signal)

In the above exemplary embodiment, reference signal RS is, for example, a signal known by both the base station and the mobile station, and may be also referred to as a reference signal (RS) or a pilot signal. For example, the reference signal may be any of a DMRS, a channel state information-reference signal (CSI-RS), a tracking reference signal (TRS), a phase tracking reference signal (PTRS), a sounding reference signal (SRS), and a cell-specific reference signal (CRS).

### (Time Interval)

In the above exemplary embodiment, a unit of a time resource is not limited to one or a combination of a slot and a symbol, and may be, for example, a unit of a time resource such as a frame, a super frame, a subframe, a slot, a timeslot subslot, a mini-slot, or a symbol, an orthogonal frequency division multiplexing (OFDM) symbol, or a single carrier-frequency division multiplexing (SC-FDMA) symbol or may be other time resource units. In addition, the number of symbols included in one slot is not limited to the number of symbols exemplified in the above-described exemplary embodiment, and may be other numbers of symbols.

### (Application to Sidelink)

The above exemplary embodiment may also be applied to communication using sidelink used for vehicle to everything (V2X) or terminal-to-terminal communication. In this case, the PDCCH may be a physical sidelink control channel (PSCCH), the PUSCH/PDSCH may be a physical sidelink shared channel (PSSCH), and the PUCCH may be a physical sidelink feedback channel (PSFCH).

### (Licensed Band and Unlicensed Band)

The above exemplary embodiment may also be applied to communication in a licensed band and an unlicensed band (unlicensed spectrum or shared spectrum). In the case of the unlicensed band, a channel access procedure (Listen Before Talk (LBT), Carrier Sense, Channel Clear Assessment (CCA)) may be performed before each signal is transmitted.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such communication apparatus include a phone (e.g., cellular (cell) phone, smart phone), a tablet, a personal computer (PC) (e.g., laptop, desktop, notebook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A transmitter according to an exemplary embodiment of the present disclosure includes: processing circuitry which, in operation, performs correction processing on one signal of a pair of transmission signals by using the other signal of the pair of transmission signals mapped to frequency resources symmetric with respect to a center frequency; and a quadrature modulator which, in operation, performs quadrature modulation on the pair of transmission signals after the correction processing.

In an exemplary embodiment of the present disclosure, the processing circuitry, in operation, performs the correction processing on the basis of at least one offset of amplitude and timing between an in-phase component and a quadrature-phase component of the pair of transmission signals.

In an exemplary embodiment of the present disclosure, the processing circuitry, in operation, generates a component for canceling the offset by using the pair of transmission signals.

In an exemplary embodiment of the present disclosure, the processing circuitry, in operation, subtracts an image signal component caused by the offset from the pair of transmission signals.

In an exemplary embodiment of the present disclosure, the processing circuitry, in operation, sets a parameter used for the correction processing for each frequency resource.

In an exemplary embodiment of the present disclosure, the processing circuitry, in operation, determines a frequency granularity that is a unit for performing the correction processing according to a change amount of the offset in a frequency domain.

In an exemplary embodiment of the present disclosure, the frequency granularity is smaller as the change amount is larger.

In an exemplary embodiment of the present disclosure, the processing circuitry, in operation, performs correction processing on the first signal and the second signal of the pair of transmission signals, and outputs, as the pair of transmission signals after the correction processing, signals of

$$s \frac{\frac{1}{{V}_{R}} {e}^{+ j ω τ} + 1}{2} + {s}^{′ *} \frac{\frac{1}{{V}_{R}} {e}^{+ j ω τ} - 1}{2}$$

$${s}^{*} \frac{\frac{1}{{V}_{R}} {e}^{- j ω τ} - 1}{2} + {s}^{′} \frac{\frac{1}{{V}_{R}} {e}^{- j ω τ} + 1}{2}$$

where s and s′ represent the first signal and the second signal mapped to frequency resources of frequencies +ω and −ω of the pair of transmission signals, respectively; V_{R} represents a correction value for an offset of an amplitude between an in-phase component and a quadrature-phase component of the pair of transmission signals of the analog section; τ represents a correction value for an offset of a timing between the in-phase component and the quadrature-phase component of the pair of transmission signals in the analog section.

In an exemplary embodiment of the present disclosure, the processing circuitry, in operation, performs correction processing on the first signal and the second signal of the pair of transmission signals, and outputs, as the pair of transmission signals after the correction processing, signals of

$$s - {s}^{′ *} \frac{{V}_{R} {e}^{- j ω τ} - 1}{{V}_{R} {e}^{- j ω τ} + 1}$$

$${s}^{′} - {s}^{*} \frac{{V}_{R} {e}^{+ j ω τ} - 1}{{V}_{R} {e}^{+ j ω τ} + 1}$$

where s and s′ represent the first signal and the second signal mapped to frequency resources of frequencies +ω and −ω of the pair of transmission signals, respectively; V_{R} represents a correction value for an offset of an amplitude between an in-phase component and a quadrature-phase component of the pair of transmission signals of the analog section; τ represents a correction value for an offset of a timing between the in-phase component and the quadrature-phase component of the pair of transmission signals in the analog section.

A transmission method according to an exemplary embodiment of the present disclosure includes: performing, by a transmitter, correction processing on one signal of a pair of transmission signals by using the other signal of the pair of transmission signals mapped to frequency resources symmetric with respect to a center frequency; and performing, by the transmitter, quadrature modulation on the pair of transmission signals after the correction processing.

The disclosed embodiments are useful for wireless communication systems.

What is claimed is:

1. A transmitter comprising:
processing circuitry which, in operation, performs correction processing on a first signal of a pair of transmission signals by using a second signal of the pair of transmission signals mapped to frequency resources symmetric with respect to a center frequency; and
a quadrature modulator which, in operation, performs quadrature modulation on the pair of transmission signals after the correction processing.

2. The transmitter according to claim 1, wherein the processing circuitry, in operation, performs the correction processing on a basis of at least one offset of an amplitude and a timing between an in-phase component and a quadrature-phase component of the pair of transmission signals.

3. The transmitter according to claim 2, wherein the processing circuitry, in operation, generates a component for canceling the offset by using the pair of transmission signals.

4. The transmitter according to claim 2, wherein the processing circuitry, in operation, subtracts an image signal component caused by the offset from the pair of transmission signals.

5. The transmitter according to claim 1, wherein the processing circuitry, in operation, sets a parameter used for the correction processing for each frequency resource.

6. The transmitter according to claim 2, wherein the processing circuitry, in operation, determines a frequency granularity that is a unit for performing the correction processing according to a change amount of the offset in a frequency domain.

7. The transmitter according to claim 6, wherein the frequency granularity is smaller as the change amount is larger.

8. The transmitter according to claim 2, wherein the processing circuitry, in operation, performs the correction processing on the first signal and the second signal of the pair of transmission signals, and outputs, as the pair of transmission signals after the correction processing, signals of
$$s \frac{\frac{1}{{V}_{R}} {e}^{+ j ω τ} + 1}{2} + {s}^{′ *} \frac{\frac{1}{{V}_{R}} {e}^{+ j ω τ} - 1}{2}$$
$${s}^{*} \frac{\frac{1}{{V}_{R}} {e}^{- j ω τ} - 1}{2} + {s}^{′} \frac{\frac{1}{{V}_{R}} {e}^{- j ω τ} + 1}{2}$$
where s and s′ represent the first signal and the second signal mapped to frequency resources of frequencies +ω and −ω of the pair of transmission signals, respectively; V_{R} represents a correction value for an offset of an amplitude between the in-phase component and the quadrature-phase component of the pair of transmission signals of an analog section; and τ represents a correction value for an offset of a timing between the in-phase component and the quadrature-phase component of the pair of transmission signals in the analog section.

9. The transmitter according to claim 2, wherein the processing circuitry, in operation, performs correction processing on the first signal and the second signal of the pair of transmission signals, and outputs, as the pair of transmission signals after the correction processing, signals of
$$s - {s}^{′ *} \frac{{V}_{R} {e}^{- j ω τ} - 1}{{V}_{R} {e}^{- j ω τ} + 1}$$
$${s}^{′} - {s}^{*} \frac{{V}_{R} {e}^{+ j ω τ} - 1}{{V}_{R} {e}^{+ j ω τ} + 1}$$
where s and s′ represent the first signal and the second signal mapped to frequency resources of frequencies +ω and −ω of the pair of transmission signals, respectively; V_{R} represents a correction value for an offset of an amplitude between the in-phase component and the quadrature-phase component of the pair of transmission signals of an analog section; and τ represents a correction value for an offset of a timing between the in-phase component and the quadrature-phase component of the pair of transmission signals in the analog section.

10. A transmission method comprising:
performing, by a transmitter, correction processing on a first signal of a pair of transmission signals by using a second signal of the pair of transmission signals mapped to frequency resources symmetric with respect to a center frequency; and
performing, by the transmitter, quadrature modulation on the pair of transmission signals after the correction processing.
